(19) United States
(12) Patent Application Publication
(10) Pub. No.: US 2004/0180702 A1
(43) Pub. Date: Sep. 16, 2004

(54) Method to reduce battery power consumption in a telephony modem by detection of loss of RF

(76) Inventor: Brent Hughes, Cumming, GA (US)

Correspondence Address: ARRIS INTERNATIONAL, INC, 3871 LAKEFIELD DRIVE, SUWANEE, GA, 30024, US

(21) Appl. No.: 10/799,077

(22) Filed: Mar. 12, 2004

Related U.S. Application Data
(60) Provisional application No. 60/454,282, filed on Mar. 13, 2003.

(51) Int. Cl. H04B 1/38; H04M 1/00

(52) U.S. Cl. 455/574

(57) ABSTRACT

Cable modem main processor and RF circuitry is turned off during off-site power loss when an RF communication channel is absent. A timer periodically wakes up the processor to determine whether an RF channel has been restored. A controller implements the timer and interacts with an RF detector. These components use less power than the main processor circuitry. Accordingly, energy is conserved while the processor is asleep.

If AC power is restored while the timer counts, the processor is awakened. If an RF channel is detected while awake, the modem reboots into ready mode.

The RF detector supplements the timer to wake up the processor if RF energy is detected so the processor can scan for potential RF channels before the timer finishes counting. The RF detector and RF circuitry of the processor may share passive components such as a coupler, filters and diplexer.

### CROSS REFERENCE TO RELATED APPLICATION

This application claims the benefit of priority under 35 U.S.C. 119(e) to the filing date of Hughes, U.S. provisional patent application No. 60/454,282 entitled “A METHOD TO REDUCE BATTERY POWER CONSUMPTION IN A TELEPHONY MODEM BY DETECTION OF LOSS OF RF”, which was filed Mar. 13, 2003, and is incorporated herein by reference in its entirety.

### FIELD OF THE INVENTION

The present invention relates generally to improving efficiency in battery-backed-up power supplies during battery operation, and more specifically to power saving during idle condition during a loss of off-site power event.

### BACKGROUND

As the use of battery-backed-up electronic devices continues to grow at a rapid pace, manufacturers are constantly trying to improve the run-down time, or time period beginning when battery operation of a device begins until the battery can no longer supply sufficient power to operate the device. By increasing the run-down time, not only can the device operate for a longer amount of time running on battery power, but the manufacture can also use smaller, less expensive batteries for a given amount of run-down time.

One way of increasing the run-down time is to use larger batteries, as the larger a battery for a given battery type, the more charge can be stored by said battery. In addition, much research is ongoing in search of different types of batteries to provide higher and higher charge densities. While current research shows promise, improvements in batteries have been limited. Thus, another way of improving run-down time is to improve the devices themselves in order to reduce the amount of power used by the given device. This is a desirable goal regardless of the type of battery being used, because any battery, no matter how exotic, will always have a given charge density associated with it, and therefore, any improvements in device efficiency are always desirable.

Such techniques that improve, or increase, the run-down time of a device are applicable to battery usage in a device that uses batteries. These techniques are especially useful in communication devices, such as devices using telephony over internet protocol, also referred to in the art as voice-over-IP or VoIP, because emergency service, such as 911 service, for example, must be provided during loss-of-off-site-power (“LOOP”) such as occurs during a storm, for example, when power lines from local utility companies may become disconnected.

Some methods of reducing power consumption in battery powered devices, as well as electrical devices powered by household current with a battery back-up include designing circuitry that consumes as little power as possible while in use and while in an idle state. Also, increasing the efficiency of uninterruptible power supply (“UPS”) components (power supply, transformer, rectifier, battery, battery charger and AC/DC converter, etc.) that provide power to a given circuit is a technique commonly used to increase run-down time.

While increasing efficiency of the processing circuits and supply circuits of a device is always desirable, and current draw may be reduced to a few milliamps while no communication is occurring, current draw could be reduced even more if the processing circuits could be shut down and not draw any current. This would seem a reasonable solution when communication is impossible because of a network connection for communication is inoperable. Such inoperability could be caused by the same thing that caused the AC off site power to be interrupted. For example, if a tree falls on a power line, thereby interrupting power to a user, the tree may also break a communication cable that is run near the power line. Therefore, even though a battery can supply power to the communication device when off site power has been lost, communication may still be impossible because there is no connection between the device and the communication network over which it normally operates. Accordingly, it seems to make sense that the main processor circuitry of the communication device would be shut down so as not to draw any current while communication to a network is impossible due to loss of a communication signal, such as an RF communication channel that a cable modem uses to communicate with a CMTS head end device.

However, communication devices that may be relied on by a subscriber for telephony or other services in an emergency would need to be able to ‘know’ when a communication channel has been restored so that a user does not have to continually check manually by turning on the device and waiting for it to reboot to determine whether communication is possible.

Thus, there is a need in the art for a method and system for detecting when a certain portion(s) of a device, such as the main processing circuitry of a cable modem or other communication device, are not being used so that these portions can be automatically placed in a ‘sleep mode’, wherein current to the portion(s) is not provided. Furthermore, there is a need in the art for the ability to automatically ‘awakened’ from sleep mode upon the restoration of communication capabilities. In addition, there is a need in the art to implement these features without power being used during sleep mode by circuitry portions for detecting when communication is desired and available.

### SUMARY

A controller circuit is used to send an instruction to a processor circuit portion of a communication device telling the portion when to enter sleep mode. Although the controller circuit remains ‘awake’ while the processor sleeps, the controller uses less power than the main processor circuitry, thus, energy is conserved while communication cannot occur. The controller current will typically be on the order of 1 mA or less, versus several hundred mA for the processor/tuner/ circuitry. The processor circuitry typically comprises computer circuitry, such as a processor, a memory, etc., and RF tuner circuitry for interfacing and coupling processor to the communication network.

While operating on battery power, the processor determines whether to enter sleep mode or not. This decision is based on the presence of AC off site power and the presence of an RF communication channel (or other type of signaling, depending on what type of network is being used by the communication device). If AC power is lost, the processor uses its RF circuitry, which is also used for communication over the network, to determine whether the device is actively connected to an RF channel. Even if an information signal is not being transmitted or received, the channel is active if the communication device has an active session connection with the network.

If not, the processor then scans for all possible channels to determine if an active session can be instituted with the network. If so, the processor remains on and tunes to the new channel. If not, the processor prepares an instruction and sends it to the controller. When the controller receives this signal, it sends out a signal to a sleep pin, or other means on the processor circuitry, telling the processor to enter ‘sleep mode’, or in other words, to turn off.

When the processor turns off, the lower-current-drawing controller starts a timer set to count down a predetermined period. During the timer count down, the controller determines whether AC power has been restored. If so, the controller tells the processor to wake up, since even processor current draw in almost negligible compared to the relatively limitless supply of power available from the AC power supply.

If AC power has not been restored when the period of time has elapsed, the controller awakens the processor and the processor then scans for all channel frequencies again. If no channels that can be made active are found, the processor instructs the controller to shut down the processor, and the timer process starts again.

This process may be supplemented by using an RF detector circuit, which is auxiliary to the processor RF circuitry. This provides the advantage that when the processor is off and the timer has expired without AC power having been restored, the processor need not be awakened to scan for RF channels.

Instead, the RF detect circuit, which draws little current compared to the processor, senses whether any RF energy is present at the communication signal input to the communication device. If not, then the processor continues to sleep. If RF energy is detected, then the processor is awakened to scan for actual RF channels. The processor is awakened because the RF detect circuitry does not include a complete RF tuner and related circuitry, but merely circuitry that can detect whether any energy in a certain frequency band is present.

Since certain noise may appear to the detector to be RF, the processor instructs the controller to begin the timer function after being awakened due RF energy being detected, if the scanning for potential communication channels is futile. Thus, the processor will not typically be turned on and off frequently, since whatever caused the noise will likely continue to be present and thus continue to cause the processor to be cycled on and off at the mere detection of RF energy. Accordingly, the RF detect feature allows the processor to remain off for an extended period of time if the network and communication device are not exposed to significant noise. If noise is present, then the timer function takes over, thereby allowing the processor to remain off for a predetermined amount of time before being awakened to scan for an actual RF communication channel.

Thus, significant power waste if the processor stays on is automatically avoided, and automatic boot-up of the communication device is resumed upon the detection of either AC power restoration or an RF communication channel becoming available.

### BRIEF DESCRIPTION OF THE DRAWINGS

FIG. 1 illustrates a system for conserving battery charge in a communication device.

FIG. 2 illustrates a method for conserving battery charge in a communication device using a timer.

FIG. 3 illustrates a method for conserving battery charge in a communication device using detection of RF energy to awaken circuitry from sleep mode following loss of RF communication channel availability.

FIG. 4 illustrates components for detecting RF energy when processor circuitry is asleep.

### DETAILED DESCRIPTION

As a preliminary matter, it will be readily understood by those persons skilled in the art that the present invention is susceptible of broad utility and application. Many methods, embodiments and adaptations of the present invention other than those herein described, as well as many variations, modifications, and equivalent arrangements, will be apparent from or reasonably suggested by the present invention and the following description thereof, without departing from the substance or scope of the present invention.

Accordingly, while the present invention has been described herein in detail in relation to preferred embodiments, it is to be understood that this disclosure is only illustrative and exemplary of the present invention and is made merely for the purposes of providing a full and enabling disclosure of the invention. This disclosure is not intended nor is to be construed to limit the present invention or otherwise to exclude other embodiments, adaptations, variations, modifications and equivalent arrangements, the present invention being limited only by the claims appended hereto and the equivalents thereof.

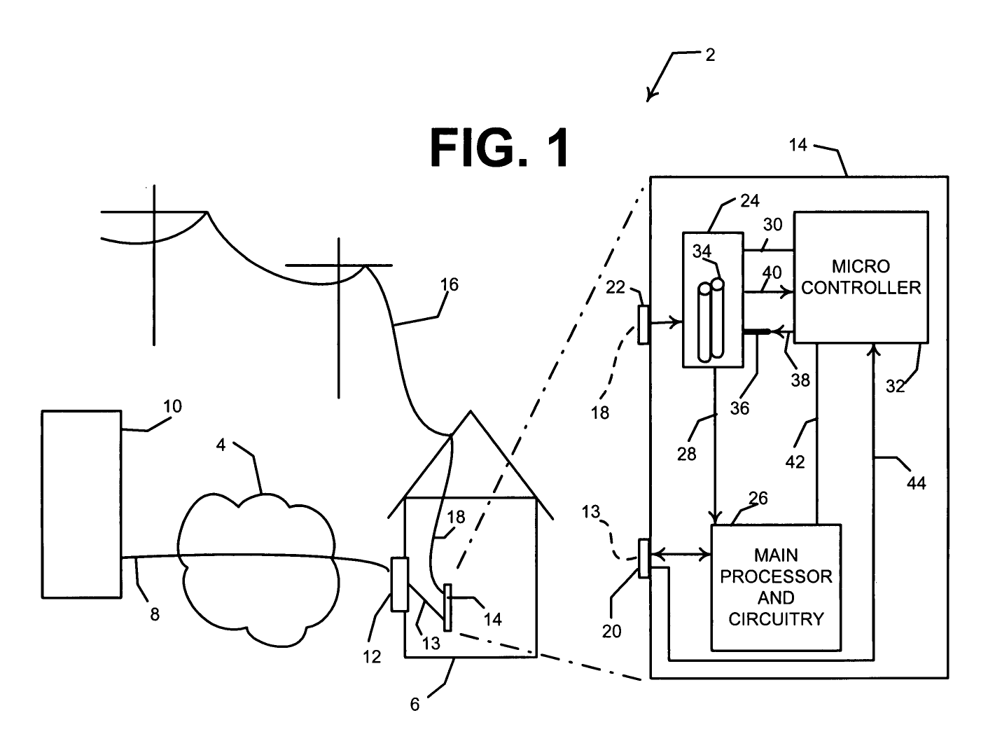

Turning now to the figures, FIG. 1 illustrates a system 2 for providing communication network services to a subscriber. System 2 includes a network 4 for connecting various subscribers, such as a subscriber who receives services at a residence 6, over a communication transport system, such as, for example, a cable T.V. network, represented by cable 8, which can be coaxial cable, fiber cable, or both, or twisted pair if network 4 is a telephony network, such as a PSTN. If network 4 is a cable television system, it is usually connected to a head end 10, which typically includes a cable modem termination system device (“CMTS”). The item referenced by numeral 10 may also be referred to as a central office when network 4 is a telephony network.

Whatever the network style or type, system 2 depicts a subscriber interface unit 12, which typically is mounted to the side of the subscriber's house 6, which has an internal communication network 13 for interconnecting various user devices that are represented by cable modem 14. During normal operation, modem 14 is typically powered by offsite power, which is typically AC household current delivered from a standard electrical power grid to house 6 though drop line 16, which provides power to the modem via internal wiring 18.

To show some of the pertinent components of modem 14, it is also shown in an expanded view in the figure, as indicated by the broken lines. This expanded view also shows a communication network connection 20, or port, and an offsite power connection 22. The power received at connection 22 provides power to UPS 24, which in turn supplies power to the main processor and circuitry, collectively referred to as item 26, on main power buss 28. The circuitry of processor 26 typically includes a microprocessor, memory, the RF circuitry, such as heterodyne circuits, Ethernet and USB interfaces, LED driver circuits and other circuits of the motherboard of modem 14. UPS 24 also supplies power on controller power buss 30 to micro controller 32, which facilitates functions that will be discussed later herein. The controller is shown in the figure as a discreet component, but may also be considered as part of the UPS circuitry. UPS 24 typically has the functionality, in conjunction with controller 32, to determine when AC power has been lost at port 22, by monitoring the DC output of the UPS AC/DC converter. When the DC level falls below a predetermined threshold, controller 32 assumes that off site power has been lost and records this into its memory.

As discussed above, processor 26 contains a microprocessor, memory (typically both flash and RAM), RF tuners and related circuitry, and other common components typically found in a cable modem, as known to those skilled in the art. Via port 20 and internal network 13, processor 26 provides full duplex communication between network 4 and various devices typically found in the home, including, but not limited to, personal computers, televisions or other video appliances, audio appliances, telephony devices, etc. Power to operate processor 26 is supplied via power buss 28, regardless of whether AC power is present at power port 22. Accordingly, UPS 24 provides constant power output, typically DC, to processor and switches from input AC power to DC power from a battery when AC off site power is lost, due to a storm or other cause that typically interrupts the delivery of AC power over a power grid operated by a local utility company. When AC power from the utility company is present at port 22, batteries 34 are charged if they are below a predetermined voltage level, and when the voltage reaches, the predetermined value, the voltage level of the batteries is monitored by the UPS to determine whether power energy should be directed to the batteries to charge them and equalize the voltage of individual cells, etc.

When power is lost and unavailable at port 22, controller 32 determines whether the UPS should deliver power to processor 26 or not. If controller 32 determines that power delivery should discontinue in order to conserve charge in battery 34, the controller instructs UPS 24 to cut power to processor. This instruction, referred to herein as the sleep signal, may typically be sent as either a high signal (voltage level) to control pin 36 on the UPS, or a low signal. The low signal is preferred as it has a lower power consumption when running off of battery power and allows the use of a normally open solid-state switch to switch off power to processor 26. The solid-state switch would close when a high signal is received at pin 36 (this condition would occur when AC power is available, and open when the high signal level is removed). Of course, those skilled in the art will appreciate that solid state or mechanical means can also be used to respond to the sleep signal at pin 36.

For example, if controller 32 determines that processor 26 should enter a ‘sleep mode,’ where power to the processor is interrupted, a low voltage signal below a predetermined threshold could be applied to buss 38, and thus to pin 36, thereby causing the UPS to turn off power to the processor circuits and conserve power drain from the battery. Alternatively, processor 26 could enter sleep mode if a high signal was applied to pin 36. The signal level, or other control signal method used to cause processor 26 to enter sleep mode will typically be based on the components used by the designers of modem 14; the particular scheme used will not be discussed further herein, except when reference is made to a control, or sleep, signal from controller 32 at pin 36 causing processor 26 to enter sleep mode.

When off site power to UPS 24 is interrupted, controller 32 detects such on power monitoring buss 40 (this is the DC voltage level detect buss). Controller 32 then sends a message on processor/controller communication buss 42 to processor 26 informing it that off site AC power has been lost.

Processor 26 uses this information in connection with its automatic—and continuously ongoing while awake—determination whether an active RF signal is present at port 20. If not, processor 26 automatically determines whether there are any RF channels present that can be made active. (An active channel or signal is one that cable modem 14 is tuned to and is currently engaged in, or is awaiting a communication message to send to network 4 via port 20.) Alternatively, controller 32 can continuously monitor port 20 via RF monitoring buss 44 and make the determination itself whether an active or available RF channel is present at port 20.

If an active channel is not present, nor available, at port 20, processor 26 sends a message to controller 32 via buss 42 conveying that the processor has decided that it should be shut down. Controller 32 removes the high signal at pin 36, causing processor 26 to enter sleep mode, and starts a timer set for a predetermined period of time. The timer is typically a software counter known in the art that performs a certain number of iterations and then terminates. However, the timer could also be a physical timer that is based on a clock, either internal to modem 14 or external, or could even be a mechanical timer. If the timer is a software timer, during each iteration of the timer, or counter, controller 32 checks buss 40 to determine if AC power (typically by detecting DC voltage level, as discussed above) from off site has been restored. If so, controller 32 instructs processor 26 to wake up by sending a high signal to UPS 24 at pin 36. If not, controller 32 continues to process counter iterations until all of the predetermined iterations have been completed. When all predetermined iterations have been performed, the counter terminates and controller 32 instructs processor 26 to wake up.

In addition to including a timer, or software that simulates a timer by processing a counter, controller 32 also may include an RF sensing circuit coupled to port 20 via RF monitoring buss 44. Thus, controller 32 can continuously monitor RF port 20 while processor 26 is in sleep mode, and decide whether to wake the processor circuitry up or not, even before the timer has stopped counting down. Accordingly, while using only the relatively low current draw of controller 32—compared to the current draw of processor 26—modem 14 can be in a low power usage state (sleep) while off site power and at least one communication channel are unavailable, and be automatically awakened upon restoration of RF channel(s) when they become available.

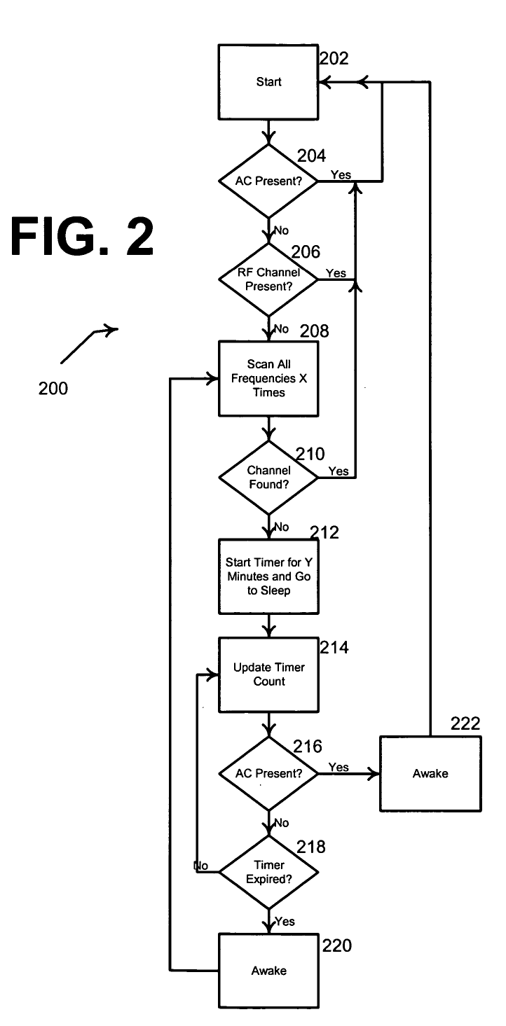

Turning now to FIG. 2, a method 200 of causing a communication device to enter sleep mode upon the loss of off site electrical power is illustrated. It will be appreciated that in describing the steps of method 200, some reference will be made to some of the components illustrated in FIG. 1, as described above. Reference numerals will refer to those components described in FIG. 1, but continual express reference to FIG. 1 will not be made.

The method, or routine, starts at step 202. If at step 204, off site AC electrical power is detected by UPS 24 at port 22, the routine returns to step 200. If UPS 24 detects that there has been a loss of off site power, routine 200 advances to step 206, where processor 26, or possibly controller 32 as discussed above, will detect whether an active RF channel is present and ready for communication at port 20. It will be appreciated that method 200 will typically comprise a computer software program that is loaded on and executed by processor 26. However, subroutines of method 200 may actually be loaded onto and executed by appropriate hardware of controller 32, as will be discussed later in this description. In addition, the steps of method 200 can also be implemented using hardware (either at processor 26 or controller 32, but typically within the processor), as will be appreciated by those skilled in the art.

If the presence of an active RF channel is detected, then control is passed back to step 202, and the routine starts again. However, if an active RF channel is not detected, then control advances to step 208, where a scan is performed at port 20 of all possible RF communication channels that may be available, by tuning the RF circuitry of processor 26 through the range of frequencies over which it is designed to operate. If channels are found that can be used for communication, the decision is made at step 210 to keep modem 14 tuned to that frequency and control of routine 200 returns to step 202.

If, however, a channel is not detected that can be used for communication, then control advances to step 212, where processor 26 sends a message to controller 32, instructing it to send a sleep signal to pin 36, causing the processor to go into sleep mode. Also at step 212, a timer, as discussed above in connection with FIG. 1, begins counting down a predetermined amount of time. FIG. 2 illustrates a software counter within controller 32 that updates the timer count at step 214 and iterates a predetermined number of passes, or loops, as known in the art. During each iteration, controller 32 determines whether AC power has been restored to UPS 24 at port 22. If not, then the timer subroutine determines at step 218 whether the predetermined number of iterations has been reached, and if not, returns control to step 214, and the next iteration begins. If the predetermined number of iterations of the timer subroutine is determined to have occurred at step 218, then routine 200 causes controller 32 to remove the sleep signal from pin 36, and processor 26 automatically begins its normal boot-up routine, ranging and registering, etc, as known in the art.

Similarly, if the presence of AC power is detected at step 216 before the timer subroutine has executed the predetermined number of iterations, then controller 32 removes the sleep signal from pin 36, and processor automatically begins its normal boot-up routine at step 222.

Accordingly, routine 200 facilitates shutting down, or ‘putting to sleep’ the processor 26 and related circuitry to save power while communication using modem 14 is not available due to lack of available RF communication channels. While processor 26 sleeps, controller 32 continually attempts to detect whether AC power has been restored. If AC power is restored, processor 26 is awakened regardless of whether an RF channel has become available, because battery run down time is no longer a concern. Moreover, even if AC power does not become available while processor 26 is asleep, the processor can be awakened periodically to check for the restoration of RF communication channels so that communication is automatically restored even when operating on battery power from UPS 24. Thus, needless waste of battery charge does not occur while attempts to communicate during an outage would be futile due to the lack of at least one RF communication channel, but communication is automatically facilitated when a communication channel becomes available, regardless of whether AC power has been restored. Therefore, a subscriber will be capable of communicating when a channel is restored, without continually having to manually cause modem 14 to reboot and search for a channel. In addition, a sensory signal, such as a quick audible sound and/or a flash of an LED may be provided to alert the subscriber that communication ability has been restored.

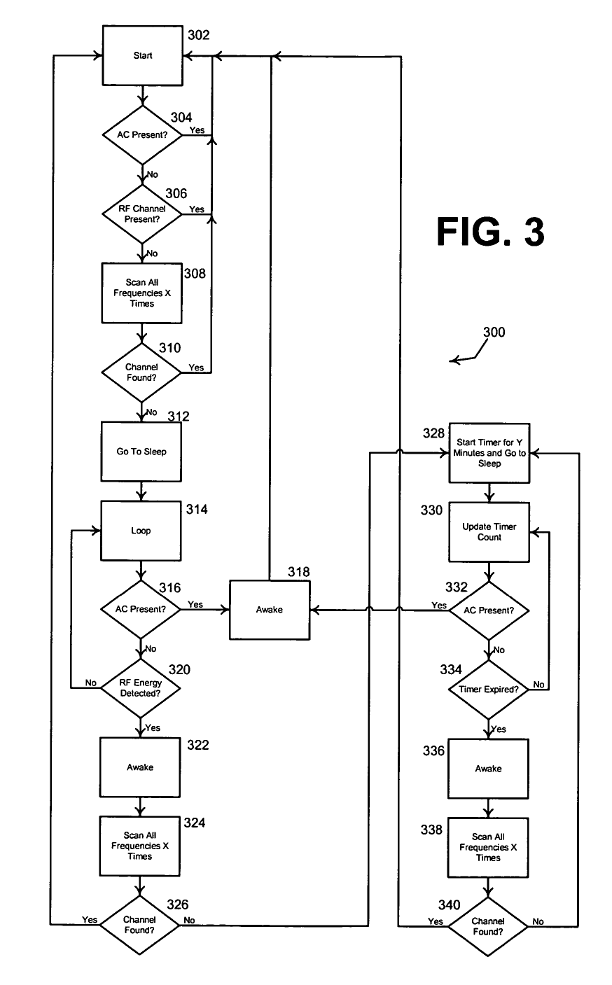

Turning now to FIG. 3, a method 300 of causing a communication device to enter sleep mode similar to method 200 of FIG. 2 upon the loss of off site electrical power is illustrated. The first steps 302-310 correspond with steps 202-210 shown and previously described in reference to FIG. 2. However, following step 310, routine 300 instructs processor 26 to enter sleep mode without starting a timer at step 312. Thus, instead of merely counting down a predetermined amount of time, before awakening processor 26, routine 300 starts a loop at step 314, during each iteration of which an attempt to detect the presence of AC power is performed at step 316. If AC power is detected at step 316, the routine removes the sleep signal from pin 36, processor 26 awakens at step 318, and control returns to step 302. If no off site AC power is detected at step 316, then routine 300 attempts to detect the presence of RF energy at step 320. This is not the same as attempting to detect the presence of an RF channel that can be made active, as at step 310, but merely to detect the presence of any RF energy. This is because the routine executes within controller 32, which has limited computing power compared to processor 26, and is not programmed to search and determine if an actual communication channel is present. The reason for this is that actual tuner functionality typically uses components that draw considerably more power than the RF detect function of the controller. The RF detect circuit is mostly passive and only has a few active components, which consume little power.

The process at step 320 only determines that signal energy in the RF band is present. If not, the routine loops back to step 314 and iterates again. If RF energy is detected at step 320, the process continues on to step 322 where processor 26 is instructed to awaken. Upon awakening at step 322, communication port 20 is scanned for the presence of communication channel frequencies at step 324. If a channel is found that can be made an active channel, the decision is made at step 326 to return to step 302. If an RF channel is not found, then process 300 continues on to step 328.

Beginning with step 328, the process is similar to that described in reference to steps beginning with step 212 shown in FIG. 2. Steps 328-336 correspond to steps 212-220 of FIG. 2, and steps 338-340 correspond to steps 208 and 210 of FIG. 2. The timer steps are used so that following a first detection of RF energy at step 320, which may or may not be an actual communication channel center frequency, process 300 can continue similarly to routine 200 shown in FIG. 2. This avoids a constant awakening and going back to sleep when spurious RF energy is detected that may be merely noise induced into infrastructure 8 shown in FIG. 1. The advantage provided by this is that as long as there is no spurious RF noise present at port 20, then the processor will not be awakened merely because a predetermined amount of time had elapsed since the loss of off site power. However, if network 4 is susceptible to noise, then routine 300 can behave as if it were routine 200 of FIG. 2, which would at least allow the processor to remain asleep for the predetermined amount of time of the timer, as opposed to constantly awakening if only the RF detection feature were part of routine 300.

Accordingly, if network 4 and line 8 of FIG. 1 exist in a relatively low-noise environment, then method 300 allows processor 26 to remain asleep until RF energy is detected a first time. When the energy is detected, the processor is awakened to use its more powerful RF circuitry to determine if the energy is from an actual communication channel. If the RF energy was not from an available channel, it is assumed to be from noise which will recur. Therefore, method 300 implements the timer function so as to avoid constant rebooting of the processor when the likelihood of communication is low.

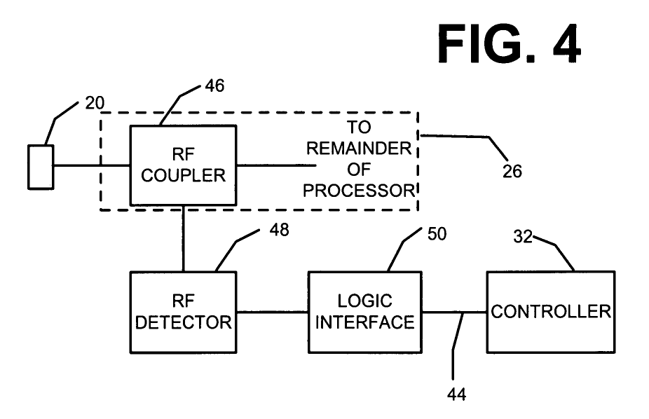

Turning now to FIG. 4, a block diagram of some of the components that provide RF interfacing to controller 32 is shown. It will be appreciated that this is a simplified diagram and that some components, such as, for example, filters and a diplexer are not shown for simplicity. However, these components would typically be located between RF port 20 and coupler 46, which is part of processor 26. Thus, the remainder of processor 26 and RF detector 48 share the diplexer and filters, since these are typically passive components and are not affected if power to processor 26 is shut down in sleep mode.

RF coupler 46 provides RF coupling circuitry known in the art, for interfacing with an RF signal, to provide functionality such as, for example, impedance matching, noise reduction and buffering/amplification. Coupler 46 is shared by the processor and controller 32 in this embodiment, although it will be appreciated that the coupling circuitry could also be discreetly part of both the processor circuitry and the controller 32 circuitry separately, but this is needless, as discussed above, because one would be duplicative of the other.

RF detector 48 includes typical radio front end components known in the art, such as, for example, detector and tuning circuitry for isolating a particular frequency or range of frequencies, and possibly heterodyne circuitry for providing intermediate or even base band frequencies. The output of RF detector circuitry 48 is provided to logic interface 50, which includes circuitry for converting the analog radio frequency signal output from detector 48 to a digital signal for input into RF monitoring buss 44. Thus, the presence of an RF signal at port 20 is provided in a format that is usable by controller 32 to determine that RF energy is present at port 20.

These and many other objects and advantages will be readily apparent to one skilled in the art from the foregoing specification when read in conjunction with the appended drawings. It is to be understood that the embodiments herein illustrated are examples only, and that the scope of the invention is to be defined solely by the claims when accorded a full range of equivalents. The aspects described herein are useful in the telephony, broadband and other communication system types. In addition, any device, such as for example, a computer, that uses batteries may also incorporate the aspects, as well as devices that are not battery-powered, but are designed to use as little power as possible to operate.

We claim:

1. A method for reducing idle-mode power dissipation in a communication device during absence of off site power, comprising:
determining whether an active radio frequency (“RF”) communication channel is present at a network connection;
scanning a plurality of possible RF channels to detect whether an RF channel is present that can be made active;
placing at least one portion of the communication device into a sleep mode if an active RF channel or an RF channel that can be made active is not detected;
starting a timer set for a predetermined period if an active channel or one of the plurality of possible RF channels is not detected; and
awakening the at least one portion from sleep mode when the predetermined period has elapsed.

2. The method of claim 1 further comprising detecting the restoration of offsite power while the timer is counting down the predetermined period and awakening the at least one portion from sleep mode.

3. The method of claim 1 wherein the at least one portion put into sleep mode includes main processor circuitry.

4. The method of claim 3 wherein the main processor circuitry includes radio frequency communication circuitry.

5. A method for reducing idle-mode power dissipation in a communication device during absence of off site power, comprising:
determining whether an active RF communication channel is present at a network connection of the communication device;
scanning a plurality of possible RF channels to detect whether an RF channel is present that can be made active;
placing at least one portion of the communication device into sleep mode if an active RF channel or an RF channel that can be made active is not detected;
determining whether RF energy is present at the network connection using an RF energy detecting means;
awakening the at least one portion from sleep mode when RF energy is detected by the RF energy detecting means; and
scanning the plurality of possible RF channels to detect whether an RF channel is present that can be made active after awakening following detection of the presence of RF energy.

6. The method of claim 5 further comprising:
starting a timer set for a predetermined period if one of the plurality of possible RF channels is not detected following detection of the presence of RF energy;
placing the at least one portion of the communication device into sleep mode if an RF channel that can be made active is not detected following starting of the timer; and
awakening the at least one portion from sleep mode when the predetermined period has elapsed.

7. The method of claim 5 further comprising determining whether offsite power has been restored and awakening the at least one portion from sleep mode upon restoration of off site power.

8. A system for reducing power consumption in a communication device having a communication network connection and using a battery backup UPS during a loss of offsite power, comprising:
a controller means coupled to the UPS for controlling operation of the UPS;
a processor means for determining whether to reduce power consumption of the communication device, said processor being coupled to the controller via a communication means; and
a switching means for placing at least one circuitry portion of the communication device in a sleep mode by interrupting power from the UPS to said at least one portion in response to a control signal from the controller.

9. The system of claim 8 further comprising an RF detecting means for determining whether RF energy is present at the network connection.

10. The system of claim 9 wherein the RF detecting means can detect the presence of RF energy while the at least one circuitry portion is in sleep mode.

11. The system of claim 8 wherein the processor includes RF communication circuitry.

12. The system of claim 9 wherein the RF detecting means and the processor share passive RF components.

13. The system of claim 8 wherein the UPS includes the switching means.

14. The system of claim 8 wherein the controller includes computing means for storing and running executable instruction code.

15. The system of claim 14 wherein the instruction code includes a timer for maintaining the at least one circuitry portion in a sleep mode for a predetermined period of time.

16. The system of claim 8 wherein the at least one circuitry portion includes the processor.

17. The system of claim 8 wherein the controller includes a monitoring means coupled to the UPS for sensing when off site AC power is present at the UPS.

18. The system of claim 8 wherein the processor means includes computing means for storing and running executable instruction code.

19. The system of claim 18 wherein the executable instruction code includes a method for making the determination as to whether to place the at least one circuitry portion in sleep mode on the presence of an active communication channel.

20. The system of claim 14 wherein the instruction code includes a method for awakening the at least one circuitry portion from sleep mode upon the occurrence of a predetermined factor.

21. The system of claim 20 wherein the predetermined factor is the elapsing of a predetermined period of time measured by a timer.

22 The system of claim 20 wherein the predetermined factor includes the detection of the presence of RF energy at the network connection.
